(19) United States
(12) Patent Application Publication
(10) Pub. No.: US 2022/0326496 A1
(43) Pub. Date: Oct. 13, 2022

(54) MICROSCOPE INTERCHANGEABLE COLLECTOR LENS DEVICE

(71) Applicant: MOTIC CHINA GROUP CO., LTD., Xiamen, Fujian (CN)

(72) Inventors: Wenjie Huang, Xiamen, Fujian (CN); Yuyan Zheng, Xiamen, Fujian (CN); Jingyun Zhuang, Xiamen, Fujian (CN)

(21) Appl. No.: 17/417,117

(22) PCT Filed: May 26, 2020
(86) PCT No.: PCT/CN2020/092246

§ 371 Date: Jun. 22, 2021

(30) Foreign Application Priority Data
Apr. 23, 2020 (CN) 202020623737.X

(51) Int. Cl. G02B 21/02; G02B 7/14

(52) U.S. Cl. CPC G02B 21/02; G02B 7/14

(57) ABSTRACT

The present disclosure provides a microscope interchangeable collector lens device, including a microscope base, a collector lens base, a collector lens, and a wrench, wherein the collector lens base is fitted and installed on the microscope base, the collector lens is mounted on the collector lens base, and the wrench is rotated to rotate the collector lens, so that the collector lens is tightened or loosened, so as to achieve the interchangeability of the collector lens, which can be correctly, smoothly and repeatedly positioned to meet the requirements of the user, with the advantages of easy operation, simple structure, strong function and low cost.

### TECHNICAL FIELD

The present disclosure relates to the technical field of microscope, in particular to a microscope interchangeable collector lens device.

### BACKGROUND

The collector lens is one of the important parts of the illumination light path system in the microscope, and it can only be adjusted according to the adjustment requirements of the Köhler illumination system. The adjustment of the collector lens system can directly affect the uniformity of the illumination in the field of view under the microscope, and can also affect the resolution of the microscope. And further, it can also directly control the contrast on the photomicrograph film. The collector lens in the existing microscope sometimes cannot be adjusted automatically due to the high and low magnification light, so that the object cannot be observed clearly. Therefore, it is very inconvenient in actual operation. The convenience of disassembly and assembly of the collector lens also directly affects whether the collector lens is required for proofreading.

In the prior art, the collector lens is installed on the collector lens base of the microscope base. If the collector lens needs to be replaced, the bottom plate of the microscope base needs to be disassembled, the snap ring used for fixing the collector lens is removed, and then the collector lens is taken out. However, this method is inconvenient for the disassembly of the collector lens, in this method, the light source in the microscope base must be removed before replacing. After installation, there are too many disassembled parts, which easily affects that the light source and the collector lens are not on the same center of the light source, thus the center of the collector lens and the light source are required to adjust again. The operation process is very complicated and cumbersome, and it also increases the damage of the collector lens or other parts during the disassembly process.

### SUMMARY

The objective of the present disclosure is to provide a microscope interchangeable collector lens device, which aims to enable the interchange of different collector lens simply and conveniently.

In order to solve the above problems, the technical solution of the present disclosure is to provide a microscope interchangeable collector lens device, including a microscope base, a collector lens base, a collector lens, and a wrench, wherein the collector lens base is fitted and installed on the microscope base, the collector lens is mounted on the collector lens base, and the wrench is rotated to rotate the collector lens, so that the collector lens is tightened or loosened.

The microscope base is provided with a circular cavity, an insertion hole, a square through-hole; the circular cavity is installed with the collector lens base, and the collector lens base is inserted in the circular cavity.

The collector lens base includes a locking insertion bar, a square through-hole and a female end slot. There are at least two of the locking insertion bar, at least six of the square through-hole. The number and the size of the square through-hole match that of the square through-hole of the microscope base.

The female end slot is opened on the inner edge of the circular cavity of the collector lens base, and there are at least four of the female end slots. The locking insertion bar is inserted into the insertion hole of the microscope base to lock the collector lens base, so that the collector lens base is fitted and installed on the microscope base.

The collector lens is provided with a male end snap buckle, and the number of the male end snap buckle matches the number of the female end slot on the inner edge of the circular cavity of the collector lens base.

The collector lens consists of a circular lens and a rim portion around the lens, the rim portion of the collector lens is a male end of the collector lens. The collector lens is mounted into the collector lens base, the male end snap buckle of the collector lens and the female end slot of the collector lens base are buckled, so that the collector lens fitted and fixed on the collector lens base.

The male end of the collector lens is matched with the female end of the wrench in correspondence. The male end of the collector lens may be in a certain shape of one of quincunx, square, hexagon, pentagon, gear, etc., and the male end of the collector lens is preferably a gear shape. Since the male end of the collector lens is made into quincunx, square, hexagon, pentagon and other shapes, the collector lens can be easily disassembled by hand screwing or simple common tools. The male end of the collector lens produces gears to form a male end gear. Because it is difficult to find a matching special tool for the internal gear, the collector lens is not easy to be disassembled. The matching of the male end gear of the collector lens and the internal gear wrench can play a role in preventing the loss and damage of the collector lens.

The distance between the collector lens and the light source is 5-9 mm, so as to prevent the collector lens from being too close to the light source. The lower part of the male end gear of the collector lens is long or short, and the distance between the collector lens and the light source is different, and a certain distance range should be maintained when the collector lens is installed.

The wrench is provided with a female end annular internal gear corresponding to the gear of the male end of the collector lens, and the inner diameter of the wrench is the same as the diameter of the collector lens, and the depth of the wrench is ≥20 mm, so as to achieve the real-time matching between the wrench and the male end gear on the collector lens, to ensure that the female end annular internal gear on the wrench is matched with the male end gear on the collector lens when using, such that the collector lens can be tighten or loosen when the wrench is rotated clockwise or counterclockwise, achieving the purpose of removing or installing the collector lens, so that the collector lens can be interchanged.

The present disclosure tightens and loosens the collector lens through the rotation of the wrench, so as to realize the interchangeability of the collector lens. The preferred one is the Kohler collector lens, the non-Kohler collector lens or the TEC collector lens, which can be positioned correctly, stably and repeatedly, so as to meet the requirements of the user. The present disclosure has the advantages of convenient operation, simple structure, strong function and low cost, and the present disclosure has through holes on the microscope base and the collector lens base, which is conducive to the heat dissipation of the light source in the base and improves the service life of the product.

### BRIEF DESCRIPTION OF THE DRAWINGS

The drawings described here are used to provide a further understanding of the present disclosure and constitute a part of the present disclosure. The exemplary embodiments of the present disclosure and the description thereof are used to elaborate the present disclosure, and do not constitute an improper limitation of the present disclosure. In the attached drawings:

FIG. 1 is a structural diagram of a collector lens base of a embodiment of the present disclosure;

FIG. 2 is a structural diagram of a wrench of the embodiment of the present disclosure;

FIG. 3 is a structural diagram of a microscope base of the embodiment of the present disclosure;

FIG. 4 is a structural diagram of the Kohler collector lens used in the embodiment of the present disclosure;

FIG. 5 is a structural diagram of a non-Kohler collector lens used in the embodiment of the present disclosure;

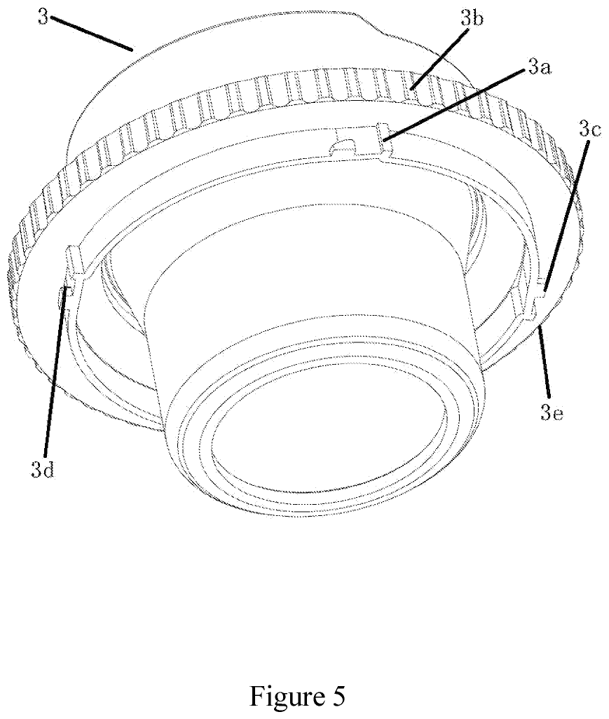

FIG. 6 is a structural diagram of a TEC collector lens used in the embodiment of the present disclosure.

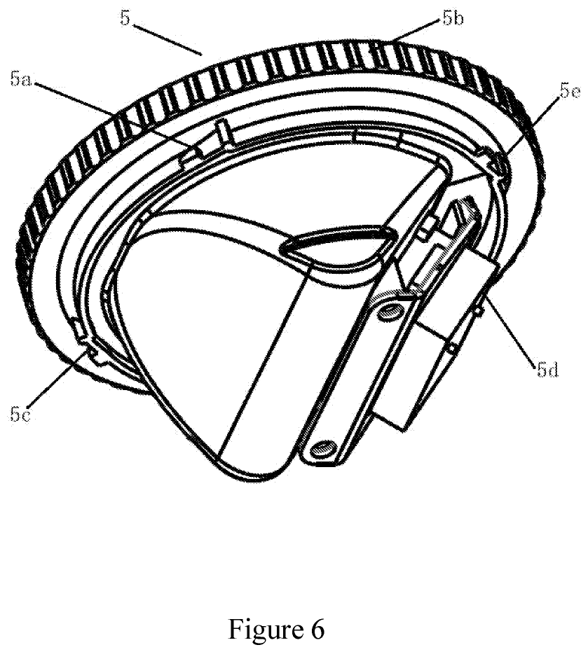

### DETAILED DESCRIPTION OF THE EMBODIMENTS

In order to enable those skilled in the art to better understand the present disclosure, the technical solution of the present disclosure is further elaborated in combination with the attached drawings and the embodiment.

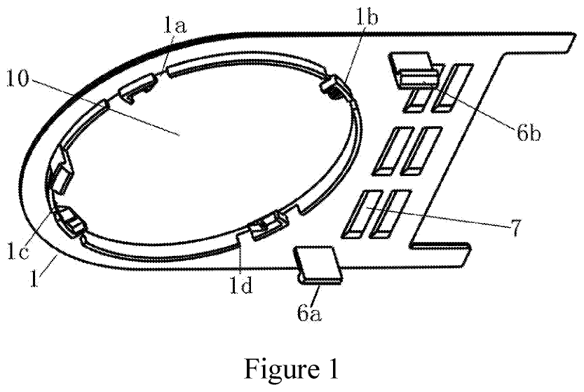

As shown in FIG. 1 to FIG. 4, the embodiment of the technical solution of the present disclosure includes: a collector lens base 1, a microscope base 13, a Kohler collector lens 2, an non-Kohler collector lens 3, a wrench 4, a TEC collector lens 5, a circular cavity 9, 10, square through-holes 7, 12, insertion bars 6a, 6b, insertion holes 8a, 8b, a female end slot 1a, male end snap buckles 2a, 2c, 2d, 2e, male end snap buckles 3a, 3c, 3d, 3e, female annular internal gear 4a and male end snap buckles 5a, 5c, 5d and 5e.

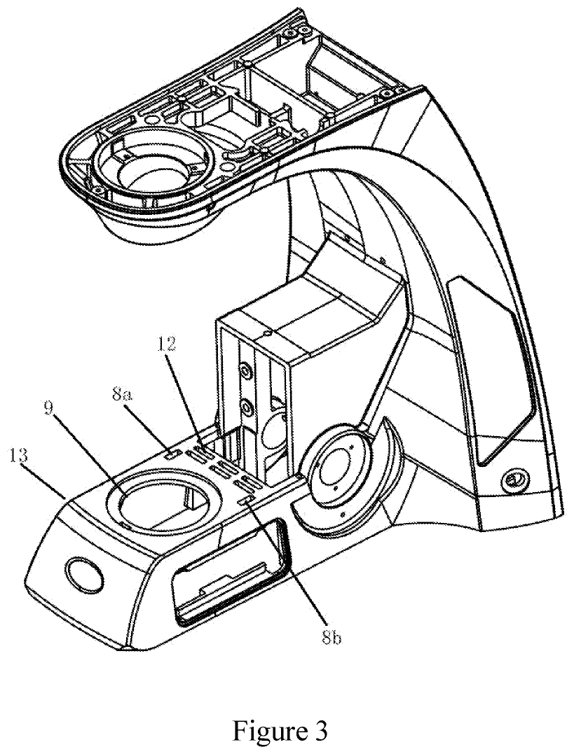

As shown in FIG. 1 and FIG. 3, the collector lens base 1 is provided with a circular cavity 10, which is matched with the circular cavity 9 of the microscope base, and the collector lens base is inserted in the circular cavity 9. The collector lens base 1 is provided with six square through-holes 7, and the six square through-holes 7 are matched with the six square through-holes 12 in the microscope base, and the square through-holes 7 and 12 play the role of heat dissipation of the light source in the microscope base.

The collector lens base 1 is provided with two insertion bars 6a and 6b, which are inserted into the insertion holes 8a and 8b of the microscope base to make the collector lens base 1 fit and fix on the microscope base.

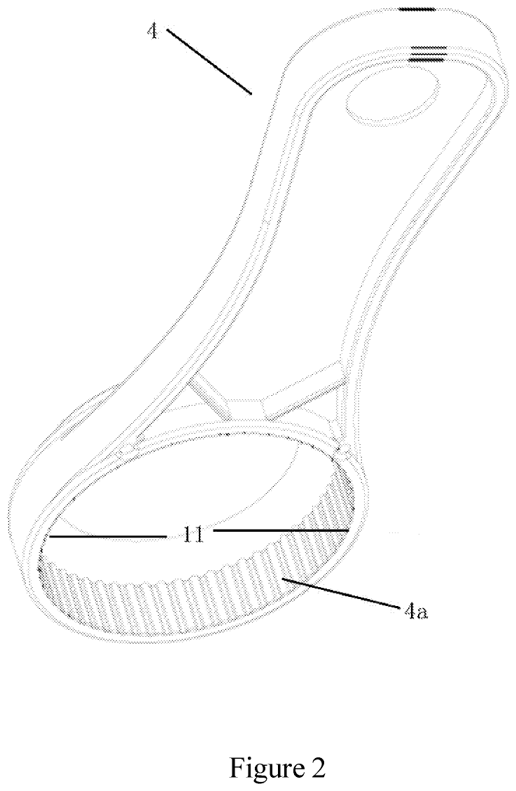

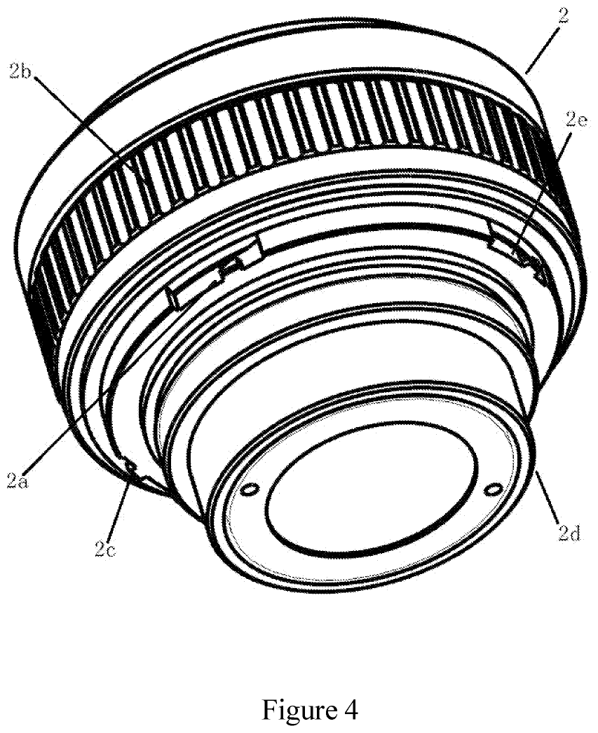

As shown in FIG. 1, FIG. 2 and FIG. 4, the collector lens base 1 is provided with female end slot 1a. In this embodiment, the number of preferred female end slots is four 1a, 1b, 1c and 1d, and the female end slots are used to match with the snap buckle on the collector lens, so that the collector lens is snapped on the collector lens base 1 through the snap buckle. Preferably, the collector lens in this embodiment takes the Kohler collector lens 2, the non-Kohler collector lens 3 and the TEC collector lens 5 as examples, there are four male end snap buckles for the Kohler collector lens 2, the non-Kohler collector lens 3 and the TEC collector lens 5 respectively, which are matched with the collector lens base 1. The male end snap buckles of the Kohler collector lens 2 are 2a, 2c, 2d and 2e, the male end snap buckles of the non-Kohler collector lens 3 are 3a, 3c, 3d and 3e, and the male end snap buckles of the TEC collector lens 5 are 5a, 5c, 5d and 5e.

The male end of the collector lens is matched with the female end of the wrench in correspondence. The male end of the collector lens may be in a certain shape of one of quincunx, square, hexagon, pentagon, gear, etc., and the male end of the collector lens is preferably a gear shape. Since the male end of the collector lens is made into quincunx, square, hexagon, pentagon and other shapes, the collector lens can be easily disassembled by hand screwing or simple common tools. While the male end of the collector lens produces gears to form a male end gear, since it is difficult to find a matching special tool for the internal gear, the collector lens is not easy to be disassembled. The matching of the male end gear of the collector lens and the internal gear wrench can prevent the loss and damage of the collector lens.

The distance between the collector lens and the light source is 5-9 mm, so as to prevent the collector lens from being too close to the light source. The lower part of the male end gear of the collector lens is long or short, and the distance between the collector lens and the light source is different, and a certain distance range should be maintained when the collector lens is installed.

In this embodiment, male end gears 2b, 3b and 5b are provided on the preferred the Kohler collector lens 2, the non-Kohler collector lens 3 or the TEC collector lens 5. The male end gears 2b, 3b and 5b are used together with the female end annular internal gear 4a provided on the wrench 4. The diameter 11 of the wrench 4 is the same as the diameter of the collector lens, in the present embodiment, the preferred diameter 11 of the wrench 4 is 68 mm, and the depth of the wrench is ≥20 mm, so as to achieve the real-time matching between the wrench 4 and the male end gears 2b, 3b, 5b on the collector lens, to ensure that the female end annular internal gear 4a on the wrench 4 is matched with the male end gears 2b, 3b, 5b on the collector lens when using, such that the collector lens can be tighten or loosen when the wrench 4 is rotated clockwise or counterclockwise, achieving the purpose of removing or installing the collector lens, so that the interchangeability of the collector lens can be realized

Through the rotation of the wrench, the present disclosure tightens and loosens the Kohler collector lens, the non-Kohler collector lens or the TEC collector lens, so as to realize the interchangeability of the Kohler collector lens, the non-Kohler collector lens or the TEC collector lens, which can be positioned correctly, stably and repeatedly, so as to meet the requirements of the user. The present disclosure has the advantages of convenient operation, simple structure, strong function and low cost.

A detailed introduction to the interchangeable collector lens lens device of a microscope provided by the present disclosure is described above. It can realize the replacement of the collector lens lens of the microscope, improve the replacement efficiency, and meet the requirements of exchanging the collector lens lens under different conditions without disassembly. The description of the embodiment is only used to help understand the method and the core idea of the present disclosure. It should be pointed out that for ordinary skilled person in the art, on the premise of not departing from the principle of the present disclosure, a number of improvements and modifications can be made to the present disclosure, and these improvements and modifications are within the scope of the claims of the present disclosure.

What is claimed is:

1. A microscope interchangeable collector lens device, comprising a microscope base, a collector lens base, a collector lens, and a wrench, wherein the collector lens base is fitted and installed on the microscope base, the collector lens is mounted on the collector lens base, and the wrench is rotated to rotate the collector lens, so that the collector lens is tightened or loosened.

2. The microscope interchangeable collector lens device according to claim 1, wherein the microscope base is provided with a circular cavity, an insertion hole, a square through-hole; the circular cavity is installed with the collector lens base, and the collector lens base is inserted in the circular cavity.

3. The microscope interchangeable collector lens device according to claim 1, wherein the collector lens base comprises a locking insertion bar, a square through-hole and a female end slot; there are at least two of the locking insertion bar, at least six of the square through-hole; the number and the size of the square through-hole match the square through-hole of the microscope base.

4. The microscope interchangeable collector lens device according to claim 1, wherein the female end slot is opened on an inner edge of the circular cavity of the collector lens base, and there are at least four of the female end slots.

5. The microscope interchangeable collector lens device according to claim 1, wherein the locking insertion bar is inserted into the insertion hole of the microscope base to lock the collector lens base, so that the collector lens base is fitted and installed on the microscope base.

6. The microscope interchangeable collector lens device according to claim 1, wherein the collector lens is provided with a male end snap buckle, and the number of the male end snap buckle matches the number of the female end slot on the inner edge of the circular cavity of the collector lens base.

7. The microscope interchangeable collector lens device according to claim 1, wherein the collector lens comprises a circular lens and a rim portion around the lens, the rim portion of the collector lens is a male end of the collector lens.

8. The microscope interchangeable collector lens device according to claim 1, wherein the collector lens is mounted into the collector lens base, the male end snap buckle of the collector lens and the female end slot of the collector lens base are buckled, the collector lens fitted and fixed on the collector lens base.

9. The microscope interchangeable collector lens device according to claim 1, wherein the male end of the collector lens is provided with a gear; the male end of the collector lens is matched with the female end of the wrench in correspondence.

10. The microscope interchangeable collector lens device according to claim 1, wherein the wrench is provided with a female end annular internal gear corresponding to the gear of the male end of the collector lens, and an inner diameter of the wrench is the same as a diameter of the collector lens.

11. The microscope interchangeable collector lens device according to claim 1, wherein a depth of the wrench is ≥20 mm.

12. The microscope interchangeable collector lens device according to claim 10, wherein a depth of the wrench is ≥20 mm.
